(19) United States
(12) Patent Application Publication
(10) Pub. No.: US 2014/0214698 A1
(43) Pub. Date: Jul. 31, 2014

(54) VIDEO SIGNATURE SYSTEM AND METHOD

(71) Applicant: Kebron G. Dejene, Campbell, CA (US)

(72) Inventor: Kebron G. Dejene, Campbell, CA (US)

(21) Appl. No.: 14/168,371

(22) Filed: Jan. 30, 2014

Related U.S. Application Data
(60) Provisional application No. 61/758,513, filed on Jan. 30, 2013.

(51) Int. Cl. G06Q 50/18; G06Q 10/10

(52) U.S. Cl. CPC G06Q 50/182; G06Q 10/10
USPC 705/309

(57) ABSTRACT

A video signature system and method. A unique identifier for an agreement document is generated. Consecutive video frames with the unique identifier are captured for each party to the agreement.

### CLAIM OF PRIORITY

The present invention claims priority from U.S. Provisional Application No. 61/758513 entitled green firma, filed Jan. 30, 2013, which is hereby incorporated by reference as if fully set forth in the present specification.

### COMPUTER PROGRAM LISTING APPENDIX

A computer program listing appendix is provided via CD-R with this application, said CD-R having a file programlistingvariousfiles.txt. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to communication systems and methods and more specifically to communication systems and methods for executing agreements.

Agreements between parties that recite the obligations of each party become binding once the agreement is executed by all of the parties involved. Each party typically signs the agreement in an area reserved for that party's signature after which the agreement is final.

It is not uncommon, however, for a party to repudiate the agreement. That is, one or more parties can claim that they never executed or signed the agreement in question. If this happens, the non-repudiating party must attempt to prove that the repudiating party did sign the agreement.

This process can be difficult as the non-repudiating party must attempt to show that the signature of the repudiating party is shown on the document. Signature analysis might be used in this respect, or the repudiating party's signature on the document can be compared to other known signatures of the repudiating party.

The non-repudiating party might also attempt to introduce secondary evidence to show that the repudiating party did sign the agreement. This might include evidence of discussions that led up to the execution of the agreement. Nevertheless, even after undergoing the process of attempting to establish that the repudiating party did sign the agreement, the non-repudiating party may still be unsuccessful in proving that the signature on the document belongs to the repudiating party.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a video signature system and method can be found in exemplary embodiments of the present invention.

In a first embodiment, the method of the present invention employs a first client computer to receive an agreement document that includes text with one or more signature areas or blocks. A party's acceptance of this agreement is signified when the party uses the signature block to execute the agreement.

After the agreement document is received, the method generates an identifier, namely, a numeric or alphanumeric number, uniquely associated with said document. Thereafter, the client computer captures consecutive video frames of the user verbalizing the identifier that is uniquely associated with the document. The consecutive video frames with the document are then stored for forwarding to the user of a second client computer.

In one embodiment, the consecutive video frames and the document are associated so that retrieving the document also provides the capability to playback the consecutive video frames. In an alternate embodiment, the consecutive video frames can be played back by selecting or interacting with a signature block area for the user's signature block area.

In this manner, when a contracting party to an agreement repudiates the agreement by claiming that he or she never executed or signed the agreement, the non-repudiating party need not engage in the difficult process of attempting to show that the signature of the repudiating party is shown on the document. The non-repudiating party can simply initiate playback of the consecutive video frames of the repudiating party to display the captured consecutive video frames of the repudiating party.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a video signature communication system according to an exemplary embodiment of the present invention.

FIG. 2 illustrates a client system showing components of a mobile device, tablet or desktop according to an exemplary embodiment of the present invention.

FIG. 3 illustrates a tablet interface according to an exemplary embodiment of the present invention.

FIG. 4 illustrates a document interface as displayed on mobile device according to an exemplary embodiment of the present invention.

FIG. 5 illustrates a mobile device interface as displayed on the mobile device of FIG. 1 according to an exemplary embodiment of the present invention.

FIG. 6 illustrates consecutive video frames according to an exemplary embodiment of the present invention.

FIG. 7A illustrates a video signature method according to an exemplary embodiment of the present invention.

FIG. 7B illustrates the continuation of the video signature method of FIG. 7B according to an exemplary embodiment of the present invention.

FIG. 8A shows a typical computer such as would be operated by a user on the Internet.

FIG. 8B shows subsystems of the computer of FIG. 8A.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

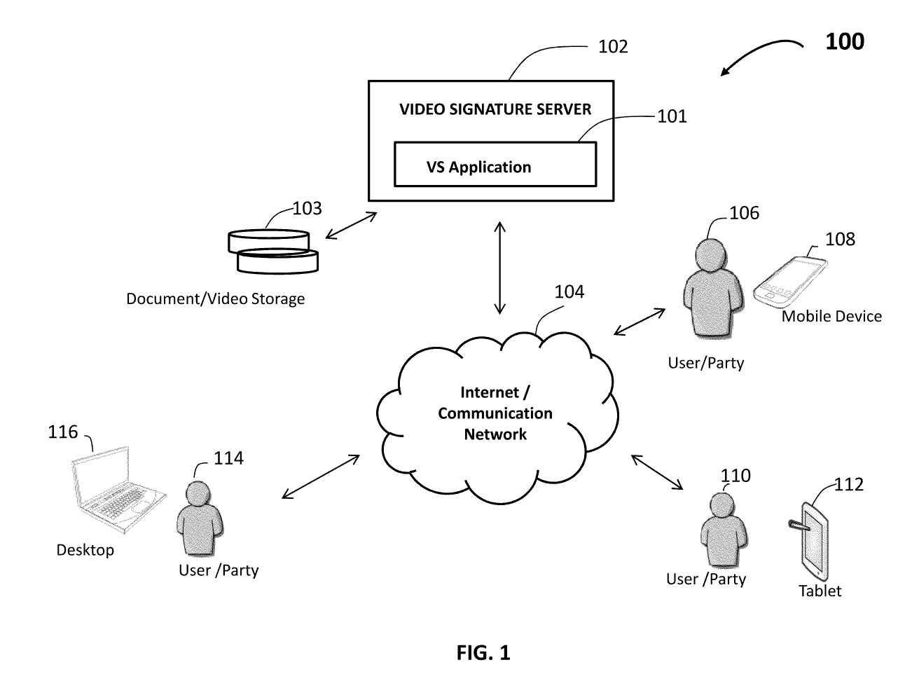

FIG. 1 illustrates video signature communication system 100 according to an exemplary embodiment of the present invention.

In FIG. 1, among other components, video signature communication system 100 comprises video signature server 102 communicably coupled to user/party 106 via Internet/communication network 104. Although not shown, Internet/communication network 104 represents any distributed network (wired, wireless or otherwise) for data transmission and receipt between two points. The system of the present invention can work effectively with any possible distribution of interconnected processors regardless of the specific topology, hardware and protocols used.

Here, user/party 106 represents a person, entity or party that intends to execute an agreement with another party. For example, user/party 106 might be a board member that needs to ratify a board decision by signing a document relating to that decision.

As another example, user/party 106 can be a doctor that needs a waiver signed in order for him or her to operate on a child. Although not illustrated, other users or parties or entity types are contemplated by the present invention so long as such users or entities wish to execute an agreement either unilaterally or in collaboration with other parties.

In FIG. 1, user/party 106 can utilize mobile device 108 to review documents, manipulate documents and transfer documents to video signature server 102 either for storage on document/video storage database 103 communicably coupled to video signature server 102. Document/video storage 103 can be any suitable database storage system. For example, document/video storage 103 can be MongoDB, a NoSQL (non-relational, next-generation operational datastore; or it might be a traditional RDBMS such as those available from Oracle, Inc.

Here, mobile device 108 might be an iPhone™ based on the iOS platform. As another example, mobile device 108 can be based on the Android™ platform. Preferably, mobile device 108 includes a video (and audio) capture device and a video player.

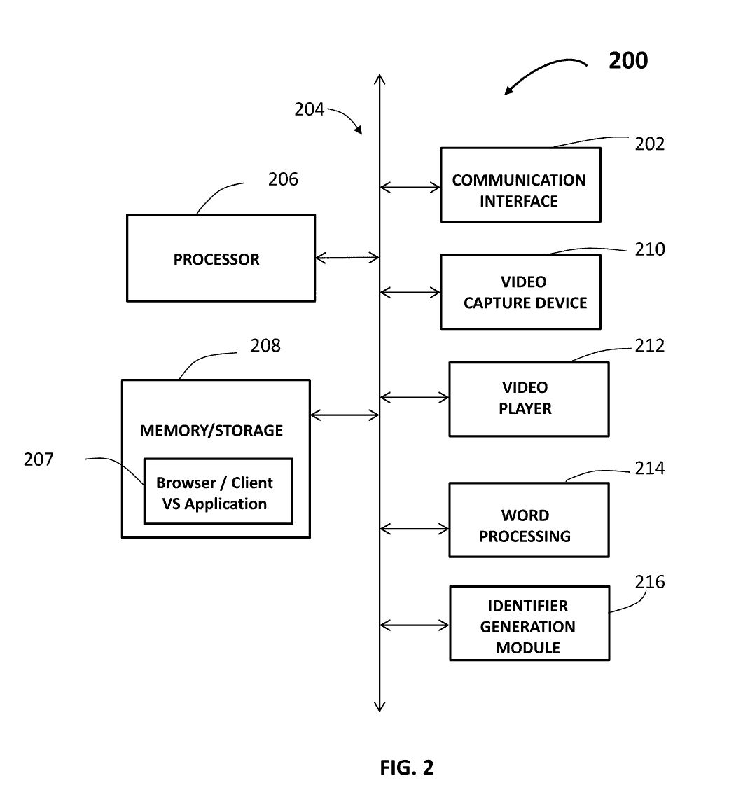

In one embodiment, mobile device 108 might include browser 207 (FIG. 2) for communication HTTP requests to video signature server 102. In an alternate embodiment, mobile device 108 can download an app Client VS Application 207 (FIG. 2) also configured to communicate with video signature server 102 (and VS Application 101). In either case, preferably most of the processing required by the present invention may be executed by video signature server 102. Although not shown, all other such future mobile communication devices are also contemplated by those of ordinary skill in the art to be within the confines of the present invention.

Here, video signature server 102 might be web/application server, a combination of processors and/or software, preferably Apache, which among other functionalities can host a website (not shown). Video server 102 might include VS Application 101 that coordinates with video signature 102 to respond to HTTP requests from mobile device 108 and can provide for downloading of various components including a video signature app (not shown), in one embodiment, and video player 212 (FIG. 2)) by mobile device 108 in accordance with the principles and precepts of the present invention.

VS Application 101 can also allow access to documents that are either executed or yet to be executed that are stored by document/video storage 103. VS Application 101 may be based on any suitable programming language, preferably JAVA, with JQuery and Twitter Bootstrap for the User Interface. Video signature server 102 might also execute various processes to implement principles and precepts of the present invention upon request by user/party 106 via mobile device 108.

In FIG. 1, video signature communication system 100 further comprises user/party 110 also communicably coupled to video signature server 102 via Internet/communication network 104. Here, user/party 110 might be another board member that needs to ratify a decision in collaboration with user/party 106.

User/party 110 might be located in a region that is geographically remote from user/party 106, and thus, documents may need to be exchanged and transferred between user/party 110 and user/party 106. As another example, user/party 110 might be a parent of a patient that needs an operation. User/party 110 may need to execute or sign a waiver from a doctor in order for an operation to proceed on user/party 110's child.

User/party 110 can utilize tablet 112 to communicate with video signature server 102 as well as user/party 106. Preferably, tablet 112 includes a video capture device and a video player. Tablet 112 may also include a browser and/or app configured to communicate with video signature server 102. Tablet 112 can be any known communication device that includes a processor for executing software routines in accordance with principles and precepts of the present invention.

In FIG. 1, video signature communication system 100 also includes user/party 114 who might also be a party to an agreement executed by user/party 106 as well as user/party 110. User/party 114 might be a third board member that also needs to ratify a decision that has been made by the entire board that includes user/party 106 and user/party 110.

User/party 114 can utilize desktop 116 for communication with the other parties as well as with video signature server 102. Preferably, desktop 116 includes a video capture device and a video player. Desktop 116 includes a browser and/or app configured to communicate with video signature server 102. Again, desktop 116 can be any traditional desktop that includes a processor, memory and input/output devices.

Briefly, in use, user/party 106 may wish to execute an agreement among multiple parties including user/party 110 and user/party 114, all of whom may be located in geographically distant regions. User/party 106 uses mobile device 108 to view agreement and to capture consecutive video frames of user/party 106 for association with each agreement document. In one embodiment, the captured video frames and document are retained locally for forwarding to other parties. In an alternative embodiment, the captured video frames and document are communicated to video signature server 102 for storage and access by user/party 110.

Upon review of the document, user/party 110 also utilizes tablet 112 to capture consecutive video frames while user/party 114 uses desktop 116 to capture consecutive video frames for association with the agreement document. Other aspects of the present invention will be illustrated with reference to FIGS. 2 through 8.

FIG. 2 illustrates client system 200 showing components of mobile device 108 (or tablet 112 or desktop 116) according to an exemplary embodiment of the present invention.

In FIG. 2, client system 200 facilitates creation or retrieval of agreement documents and the capture of consecutive video frames for association with said an agreement document. Client system 200 includes processor 206 and communication interface 202 that interfaces via system bus 204. Processor 206 coordinates system operations and directs communication interface 202 to transmit and receive data from signature video server 102.

Communication interface 202 can be any suitable communication interface that allows data transfer from the system as well as to the system. Client system 200 also includes video capture device 210 such as a camera and video player 212. Video player 212 can be software downloadable from video signature server 102/VS Application 101 or that exists as part of mobile device 108 for playback of consecutive video frames captured in accordance with the present invention.

Client system 200 also includes word processing module 214 and identifier generation module 216. Word processing module 214 can be any known word processor for manipulating text and creating documents. Each document created is configured such that one or more signature block areas are created where parties can execute the agreement with their signatures.

Identifier generation module 216 can be software or hardware that generates identifiers associated with agreements in accordance with the present invention. In one embodiment, identifiers are based on a hash of the document that provides a unique identifier that can only be produced by the document.

After each document is created, identifier generation module 216 is automatically initiated to generate a unique identifier for the document. If the document is in existence, the identifier generation module 216 is initiated by saving the document.

Client system 200 also includes memory/storage 208 which can be any suitable memory in which programs executed by processor 206 are stored. As shown, depending on the embodiment, memory/storage includes browser or client VS application 207. Browser 207 preferably uses RecordRTC (https://www.webrtcexperiment.com/RecordRTC/) to capture consecutive audio and video frames for transfer to video signature server 102.

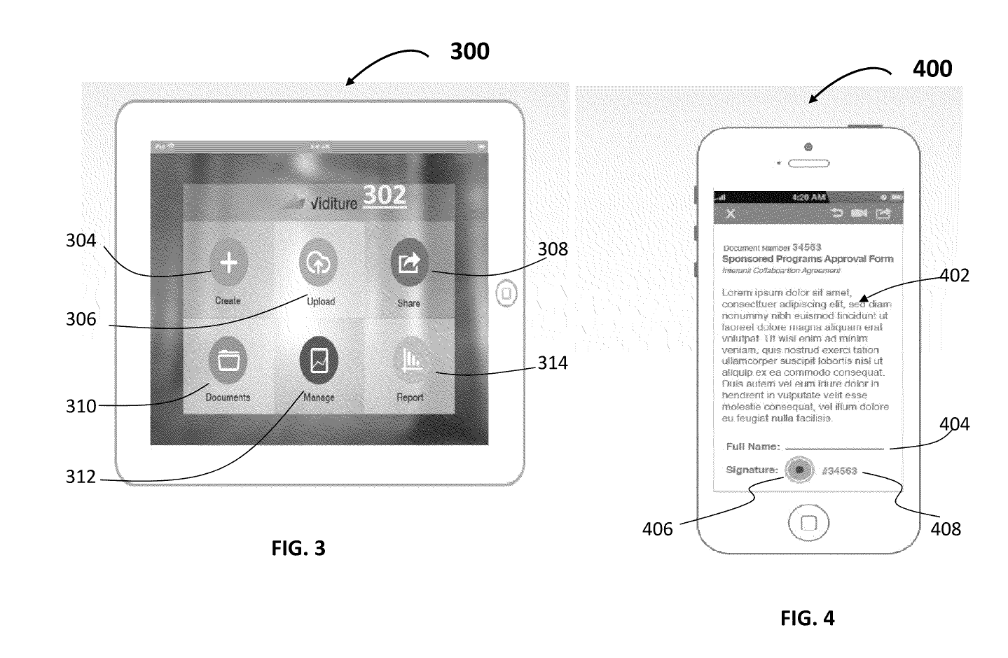

FIG. 3 illustrates tablet interface 300 of tablet 112 (FIG. 1) according to an exemplary embodiment of the present invention.

In FIG. 3, tablet interface 300 displays viditure application 302 for implementing video signature in accordance with the present invention. The inventors have named this invention “viditure” defined as the capability to utilize consecutive video frames (and audio frames) of a user to execute documents (and financial instruments).

As can be seen, in FIG. 3, viditure application 302 includes create button 304 and upload button 306. Create button 304 may be used to initiate word processing module 214 (FIG. 2) in order to create or to review documents that need to be executed or that have been executed with the requisite signatures. Upload button 306, as implied by its name, can upload documents to video signature server 102 for storage and/or transmission to other parties that are party to an agreement.

Tablet interface 300 also includes share button 308 and documents button 310 that can be selected to show documents either locally on the client or that have been transferred to video signature server 102. Share button 308 allows user/party 106 to share documents and corresponding consecutive video frames. Sharing/transmitting of documents might be accomplished via an email server (not shown) within or outside of the communication system. Manage button 312 permits documents and video frames stored locally while report button 314 enables user/party 106 to generate requisite reports.

FIG. 4 illustrates document interface 400 as displayed on mobile device 108 according to an exemplary embodiment of the present invention.

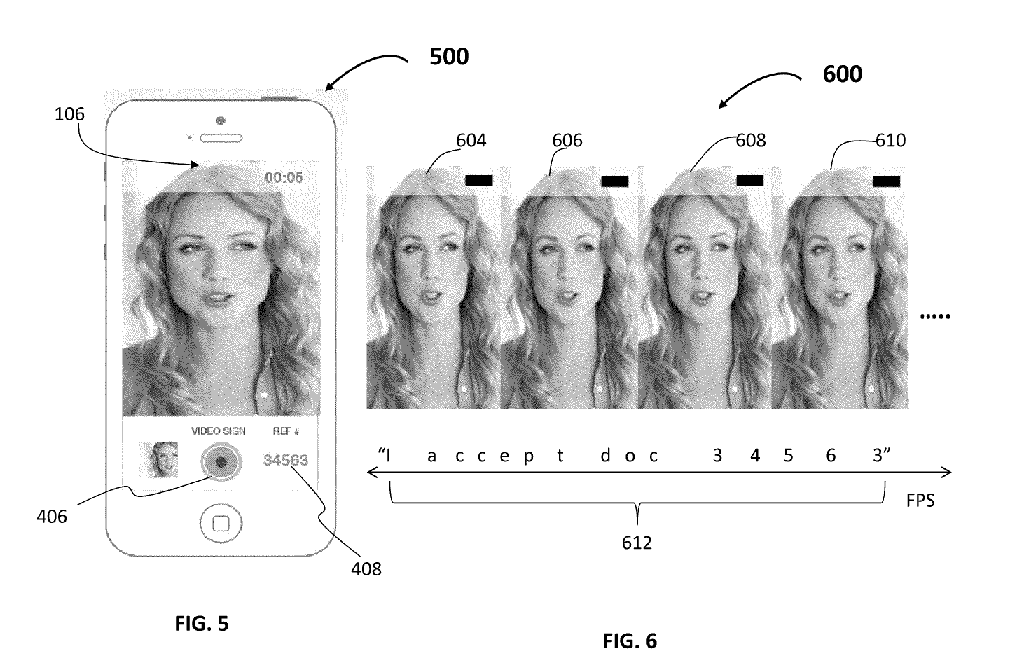

In FIG. 4, as shown, text 402 showing terms of the agreement has been displayed. User/party 106 can execute this agreement by entering his or her name at signature block 404 and then selecting video sign button 406 that initiates capturing of consecutive video frames as shown with reference to FIGS. 5 and 6.

FIG. 5 illustrates mobile device interface 500 as displayed on mobile device 108 according to an exemplary embodiment of the present invention.

In FIG. 5, mobile device interface 500 shows user/party 106 during a consecutive video frame and audio capture process. Here, user/party 106 has selected video sign button 406 in order to begin capturing consecutive video frames of herself for a document uniquely identified as 34563 as shown at 408.

Upon selecting video sign button 406, video capture device 210 (FIG. 2) is initiated. As can be seen in FIG. 6, consecutive video frames 604, 606, 608, 610 are captured by video capture device 210. Consecutive video frames 604, 606, 608 and 610 specifically capture user/party 106 verbalizing the words, “I accept document 34563” 612. The captured consecutive video frames and audio are then passed to browser/client VS application 207 (FIG. 2).

The captured consecutive video frames are also associated with unique numeric (or alphanumeric) identifier 34563. By associating, it is meant that retrieving or opening the document having identifier 34563 also retrieves or provides the ability to playback consecutive video frames 604, 606, 608 and 610.

In one embodiment, consecutive video frames 604, 606, 608 and 610 or its corresponding video file are embedded in signature block 404 area. In this manner, the consecutive video frames (and audio) can be played back by selecting or interacting with the signature block 404 area to display party/user 106 verbalizing the statement “I accept document 34563.” Although not shown, note that a timestamp indicating when the video frames were captured and geo-location of parties are captured as well.

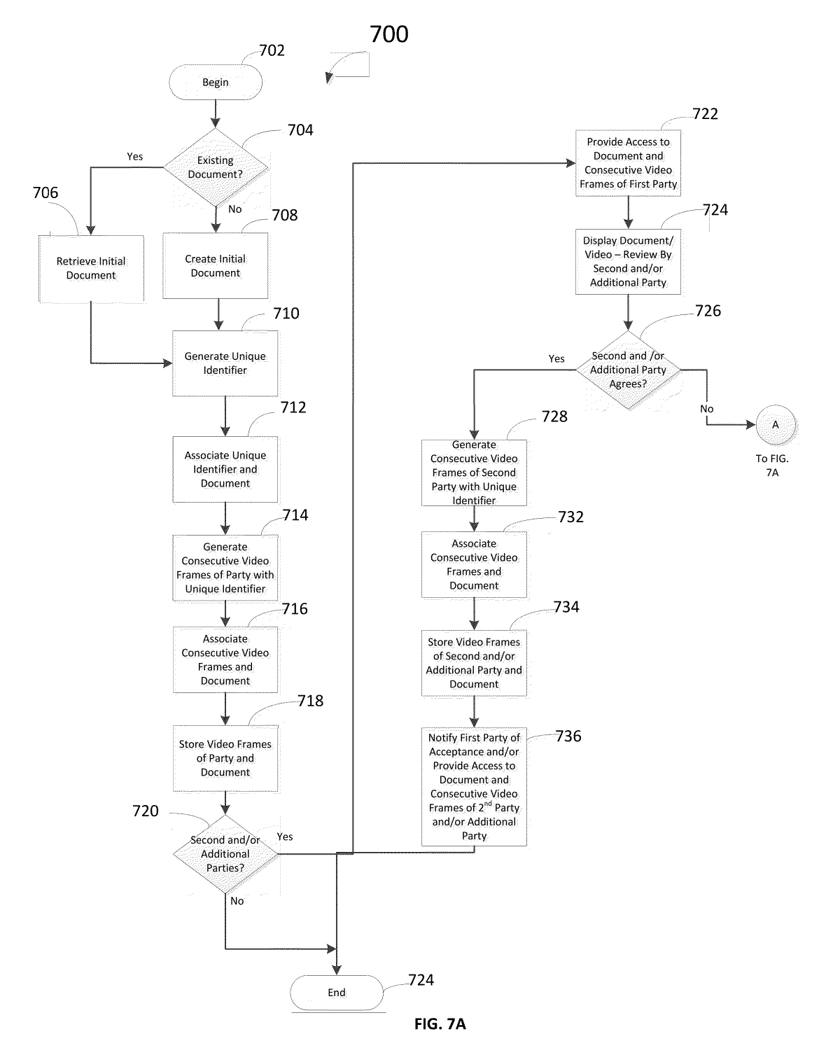

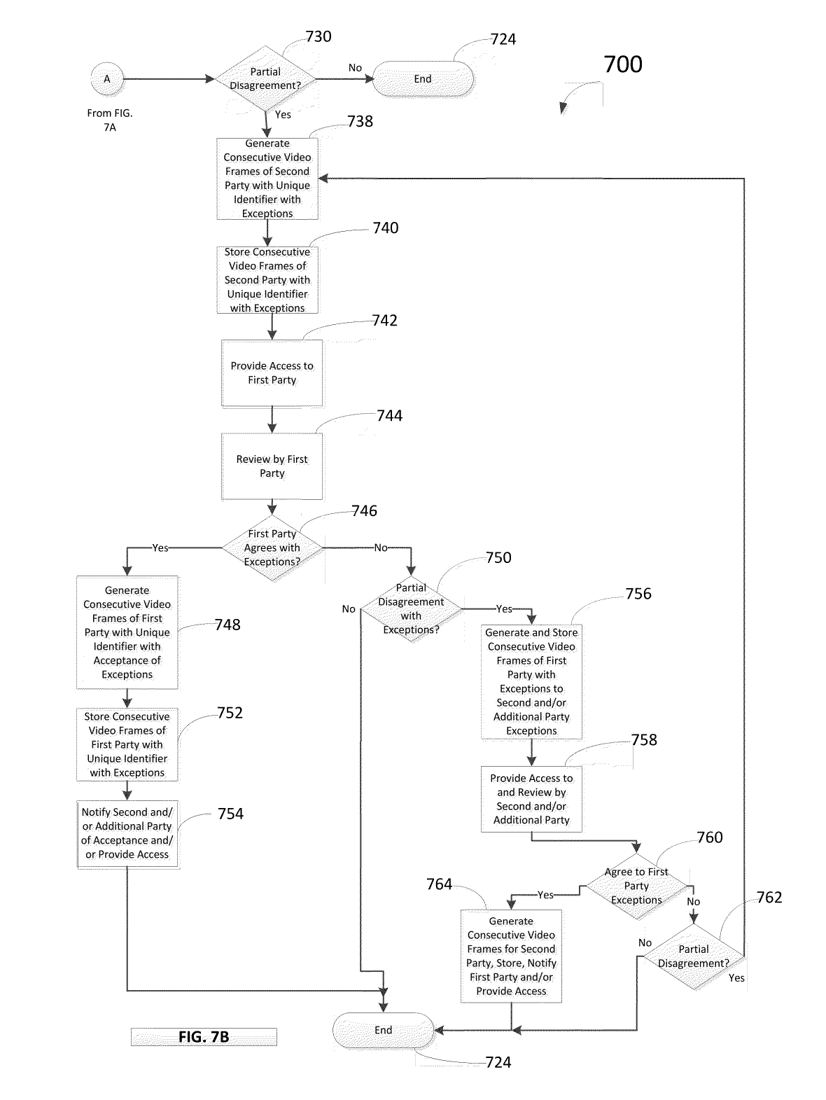

FIG. 7A illustrates method 700 according to an exemplary embodiment of the present invention.

In FIG. 7A, method 700 enables users and parties to utilize consecutive video frames and audio to execute agreements and in one embodiment, embed said video frames in corresponding signature blocks on the document. Consequently, each document is embedded with consecutive video frames of each party to the agreement and then thereafter stored at a designated server, namely video signature server 102, or at the client locations as determined by the operator of the present invention.

At begin block 702, method 700 is initiated.

At decision block 704, it is determined whether there is an existing document, namely, a document that needs to be executed as part of an agreement. That is, the document contains text configured into terms of an agreement as well as configured to form signature blocks for each party to the agreement.

If there is an existing document or agreement at 706, that initial document or existing document is retrieved. If there is no existing document, at 708, an initial document is created for the agreement.

Specifically, as an example, user/party 106 (FIG. 1) uses viditure application 302 (FIG. 3) on mobile device 108 to initiate word processing module 214 (FIG. 2) in order to create the document.

After the document is created or retrieved, at block 710, a unique identifier is generated for the document. In one embodiment, the unique identifier may be generated locally by identifier generation module 216. In an alternate embodiment, the unique identifier is generated by video signature server 102 and then downloaded to client mobile device 108.

At 712, the identifier is uniquely associated with the agreement document. It is noted that the identifier itself may be based on the document itself. That is the identifier may be a hash of the document so that an identifier that is uniquely associated with the document is created. By associating the identifier on the document, any reference or pointer to the identifier immediately retrieves the document.

At block 714, consecutive video frames of user/party 106 are generated. Specifically, in one embodiment, user/party 106 selects video sign button 406 (FIG. 5). Upon selecting video sign button 406, video capture device 210 (FIG. 2) is initiated. User/party 106 then begins to verbalize the unique identifier generated and that is uniquely associated with the document.

Specifically, user/party 106 indicates her assent to the terms of the agreement by vocalizing the unique identifier, and as she verbalizes the unique identifier, consecutive video frames are captured. As shown in the example of FIG. 6, video frames 604, 606, 608 and 610 capture user/party 106 as she verbalizes her acceptance of the agreement as shown at 612 (FIG. 6). Specifically, user/party 106 states, “I accept document 34563,” all of which is captured by consecutive video frames 604, 606, 608 and 610.

At 716, the system associates the consecutive video frames and the document. Thus, any reference to the consecutive video frames also points to the document, and any reference to the document points to the consecutive video frames.

At 718, the consecutive video frames are stored as a video file and then stored with the document. The video file and the document may be stored locally on mobile device 108 or uploaded to video signature server 102 for storage on document/video storage database 103 and subsequent transmission to or access by other parties to the agreement.

At decision block 720, it is determined whether there are second and/or additional parties that have to execute or sign the agreement document. If yes, method 700 proceeds to block 722. If no, method 720 proceeds to 724 to end block 724, and the method is terminated. In other words, only the agreement executed by a single party, in this case, user/party 106, is captured as in the case of a check, for example, executed by a user for tender to a bank.

At block 722, since there is a second or additional party, access to the document and consecutive video frames of user/party 106 is provided. For exemplary purposes, it is assumed that the second party is user/party 110 of FIG. 1. In one embodiment, user/party 110 accesses the documents executed by user/party 106 via links sent to user/party 110.

The links are configured to provide access or to retrieve the documents from video signature server 102. In an alternate embodiment, user/party 110 can also obtain the documents executed by user/party 106 by separately logging into a website hosted by video signature server 102. In a further embodiment, user/party 106 can simply attach the executed document and the consecutive video file to an email for forwarding to user/party 110.

At block 724, user/party 110 retrieves the document and reviews the document for acceptance. That is, user/party 110 displays the document reviews, the entirety of the document to see if the user wishes to accept the agreement based on the terms displayed on the user's device.

At decision block 726, if user/party 110 agrees with the terms of the document, method 700 proceeds to block 728. Otherwise, execution proceeds to decision block 730 of FIG. 7B.

At block 728, user/party 110 uses tablet 112 (FIG. 1) to initiate video capture device 210 (FIG. 2) in order to capture consecutive video frames of user/party 110 as the user verbalizes the unique identifier associated with the agreement document. This follows a similar process as that described with reference to FIGS. 5 and 6.

At block 732, the consecutive video frames now starting a file are associated with the document. In other words, reference to the consecutive video files of user/party 110 verbalizing the unique identifier to indicate agreement with the terms of the document, acts as a pointer to the document and vice versa.

Note that initiation or interaction with the specific signature block designated for user/party 110 on the document initiates playback of the consecutive video files captured for user/party 110. (Interaction with a specific signature block designated for user/party 106 also initiates playback for video frames captured for user/party 106.)

At block 734, the video frames for user/party 110 are stored.

At block 736, user/party 106 is notified of the acceptance of user/party 110 and/or access is provided to user/party 106 to the recorded consecutive video frames as stored with or embedded within the document. The method then proceeds to end block 734.

At this point, user/party 110 and user/party 106 have indicated their acceptance by capturing consecutive video frames of themselves viditurizing their video signatures which in one embodiment are embedded in respective signature blocks for each party or otherwise associated with the document. In this manner, parties cannot repudiate the fact that they executed the agreement document since consecutive video frames of each party vocalizing or verbalizing their acceptance of the document based on the unique identifier for the document.

Now referring to FIG. 7B, which illustrates method 700 as continued from A of FIG. 7A, at decision block 730, it is determined whether user/party 110 has a partial disagreement with the terms of the agreement document. If there is no partial disagreement, execution of method 700 proceeds to end block 724.

At block 738, if user/party 110 has a partial disagreement with the terms of the agreement document as received from user/party 106, user/party 1110 can simply generate consecutive video frames of her with the unique identifier and with whatever exceptions that she disagrees with. For example, if she disagrees with paragraph 5, she can verbalize her agreement with the document by verrbalizing the unique identifier but then stating that she disagrees with paragaph 5 for example. She may also state her specific disagreements in the paragraph which are also captured as consecutive video frames that can be reviewed by user/party 106.

At block 740, the consecutive video frames captured by user/party 110 are stored with the unique identifier and with exceptions.

At 742, user/party 106 is provided with access to the agreement document including the consecutive video frames recorded with exception by user/party 1110.

At block 744, user/party 106 reviews the exceptions and any specific comments regarding the exceptions to see if she agrees with those exceptions.

At decision block 746, if user/party 106 agrees with the comments, execution of method 700 proceeds to block 748, and if she disagrees with the exceptions, execution of method 700 proceeds to block 750.

At block 748, user/party 106 agrees with the exceptions and thus, consecutive video frames of user/party 106 are captured as user/party 106 verbalizes acceptance of the unique identifier with whatever exceptions were stated by user/party 110.

At block 752, the consecutive video frames are stored with the unique identifier with exceptions. At block 754, user/party 110 is notified that user/party 106 has accepted the agreement with exceptions or access can be provided to user/party 110 to access the consecutive video files as captured by user/party 106 accepting the terms of the document with exceptions. Thereafter, execution proceeds to end block 724.

Returning to decision block 750, if user/party 106 has no partial disagreement with exceptions, execution of method 700 is terminated and proceeds to end block 724.

On the other hand, if user/party 106 has a partial disagreement with the exceptions, at block 756, consecutive video frames of user/party 106 with exceptions to the exceptions by user/party 110 are generated and stored.

At block 758, method 700 provides access to and review by user/party 110.

At decision block 760, if user/party 110 agrees to the exceptions by user/party 106, execution proceeds to block 762 where consecutive video frames for user/party 110 are generated and then stored. Notification of user/party 106 or access is provided to user/party 106 to view the consecutive video frames forming the basis of the assent to the agreement.

At decision block 760, if user/party 110 does not agree with user/party 106's exceptions, execution proceeds to decision block 762. At decision block 762, if user/party 110 has no partial disagreement, execution proceeds to end block 724. However, at decision block 762, if there is a partial disagreement with user/party 106's exception, method 700 proceeds back to block 738.

At decision block 760, if user/party 110 agrees with user/party 106's exceptions, execution proceeds to block 764 where consecutive video frames for user/party 110, are stored, and user/party 110 is either notified or access to the stored consecutive video frames for user/party 110 is granted.

In another embodiment, the present invention contemplates capturing an image of a driving license, comparing that to the consecutive video frames to authenticate a user/party.

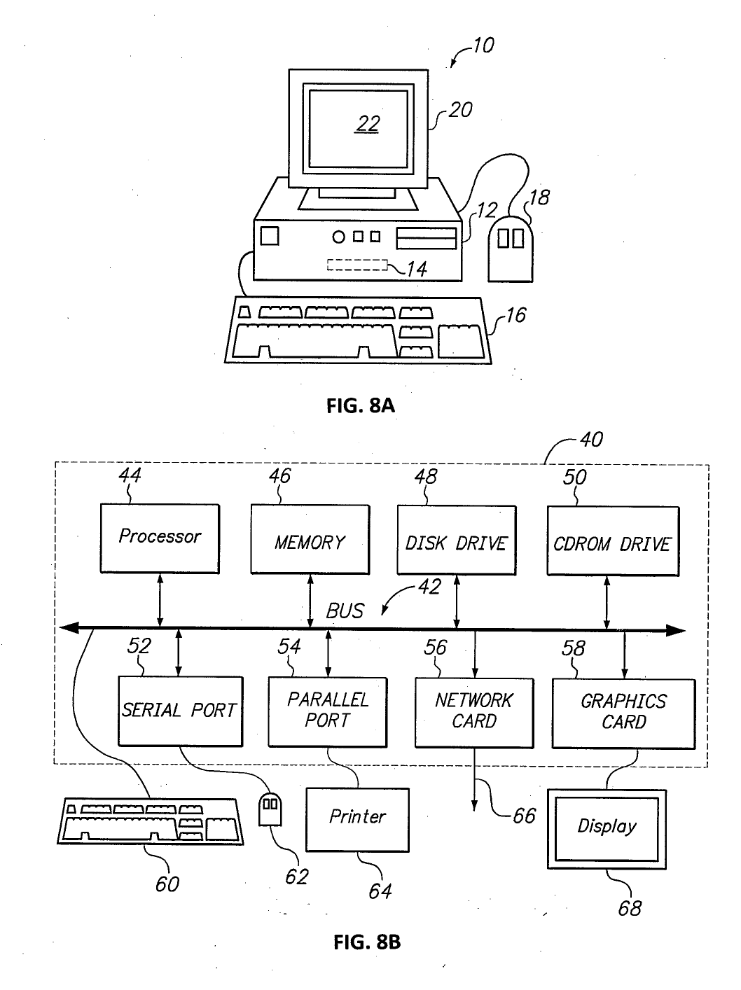

FIG. 8A shows a typical computer 10 such as would be operated by a user /party on the Internet. Computer 10 includes a cabinet 12 housing familiar computer components such as a processor, memory, disk drive, Compact Digital Read Only Memory (CDROM), etc. (not shown). User input devices include keyboard 16 and mouse 18. Output devices include display 20 having a display screen 22. Naturally, many other configurations of a computer system are possible. Some computer systems may have additional components to those shown in FIG. 8A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 8A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 8A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 8B shows subsystems of the computer of FIG. 8A. In FIG. 8B, subsystems within box 40 are internal to, for example, the cabinet 12 of FIG. 8A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system and some of the subsystems shown in FIG. 8B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method comprising:
receiving, at a client computer, a document configured to have text forming at least one or more signature areas or blocks, wherein execution of the at least one or more signature areas or block indicates acceptance by a user of said client computer to form an agreement;
using said client computer to generate an identifier, namely, a numeric or alphanumeric number, uniquely associated with said document that is configured to have text forming at least one or more signature areas or blocks;
accepting signals from a user input device of said client computer to capture consecutive video frames of the user verbalizing the identifier that is uniquely associated with the document, wherein said user verbalizing said identifier is configured to form an agreement by indicating acceptance of terms of said document;
storing, by said client computer, said consecutive video frames in a video file and associating said video file with the document; and
upon user selection or interaction with the at least one or more signature areas or blocks of the document, initiating playback of said video file including said consecutive video frames displaying the user verbalizing said unique identifier and authenticating the user's acceptance of said agreement.

2. The method of claim 1 further comprising
receiving, at a second client computer, the document and the associated video files for review by a user of said second client computer;
accepting signals from a user input device of said second client computer to capture consecutive video frames of the user of said second client computer as said user verbalizes the identifier uniquely associated with the document to accept terms of the document to form said agreement;
storing said consecutive video frames of the user of said second client computer in a second video file and associating said second video file with the document such that playback of said consecutive video frames is initiated by interacting with or selecting a second signature block of said document, playback of said consecutive video frames displaying the user of said second client computer verbalizing said unique identifier and authenticating the user of the second client computer's acceptance of said agreement.

3. A method comprising:
generating, at a first client computer, a document configured to have text that form at least one or more signature areas or blocks, execution of a signature block indicating acceptance by a user of said client computer to form an agreement;
generating, by said first client computer, a unique identifier namely a numeric or alphanumeric number uniquely associated with the document configured to have text forming the at least one or more signature areas or blocks;
accepting signals from a user input device of said client computer to capture a first set of consecutive video frames of the user of said first client computer verbalizing the identifier uniquely associated with the document to accept terms of the document to form said agreement; and
storing said first set of consecutive video frames in a first video file and associating said first video file with the document such the user's acceptance of said agreement may be authenticated by playback of said video file displaying the user verbalizing said unique identifier.

4. The method of claim 3 further comprising
authenticating said document by using a second client computer to display the document and the first set of consecutive video frames of the user of said first client computer.

5. The method of claim 4 further comprising
accepting signals from a user input device of said second client computer to capture a second set of consecutive video frames of the user of said second client computer verbalizing the identifier uniquely associated with the document to accept terms of the document to form said agreement.

6. A computer program product including a non-transitory computer readable storage medium having executable code, the code when executed by a processor is adapted for performing the following:
generating, at a first client computer, a document configured to have text that form at least one or more signature areas or blocks, execution of a signature block indicating acceptance by a user of said client computer to form an agreement;
generating, by said first client computer, a unique identifier namely a numeric or alphanumeric number uniquely associated with the document configured to have text forming the at least one or more signature areas or blocks;
accepting signals from a user input device of said client computer to capture a first set of consecutive video frames of the user of said first client computer verbalizing the identifier uniquely associated with the document to accept terms of the document to form said agreement; and
storing said first set of consecutive video frames in a first video file and associating said first video file with the document such the user's acceptance of said agreement may be authenticated by playback of said video file displaying the user verbalizing said unique identifier.

7. The computer program product of claim 6 further comprising
authenticating said document by using a second client computer to display the document and the first set of consecutive video frames of the user of said first client computer.

8. The computer program product of claim 7 further comprising
accepting signals from a user input device of said second client computer to capture a second set of consecutive video frames of the user of said second client computer verbalizing the identifier uniquely associated with the document to accept terms of the document to form said agreement.
